(19) United States
(12) Patent Application Publication
(10) Pub. No.: US 2002/0184383 A1
(43) Pub. Date: Dec. 5, 2002

(54) Live mobile camera system with a communication protocol and a server cluster

(75) Inventor: Yu Song, San Carlos, CA (US)

Correspondence Address: Richard E. Stanley, Jr., Brinks Hofer Gilson & Lione, P.O. Box 10395, Chicago, IL, 60610, US

(73) Assignee: DoCoMo Communications Laboratories USA, Inc.

(21) Appl. No.: 09/867,730

(22) Filed: May 29, 2001

(51) Int. Cl. G06F 15/16

(52) U.S. Cl. 709/236; 709/203

(57) ABSTRACT

A live mobile camera system is provided with a variable segment size communication protocol and a two tier server cluster. The variable segment size communication protocol segments digital data into segments in an application layer and packetizes the segments in an internet protocol layer. One embodiment of the communication protocol is used with a wireless link and uses the internet protocol known as user datagram protocol. The two tier server cluster includes a first tier of servers. Each of the first tier servers manage more than one second tier server and may reassign the second tier servers to other first tier servers.

### BACKGROUND

The present invention relates generally to electronic networks, and more particularly, to communication between a client and a server.

The growth of client-server networking technology has made numerous communication applications available. Most current networking applications provide only limited functionality, however. These applications typically involve a number of clients that communicate with one or more independent servers. The servers are commonly referred to as application servers, or database servers, since they store data that can be accessed at the request of the clients.

One networking application that provides greater utility is a live mobile camera system. Typically live mobile camera systems include a mobile client which is connected to a network, usually through a wireless link to allow the mobile client to freely travel from place to place without the need for a hardwire link to the network. The mobile client is further provided with a camera for acquiring visual pictures of the area surrounding the mobile client and a GPS receiver for retrieving the geographical location of the mobile client. Thus, the mobile client is able to transmit visual pictures and geographical data back to the application server. The browser client may control certain functions of the mobile client by transmitting commands to the mobile client through the server system. The browser client may also view a particular mobile client or a group of mobile clients within a specified vicinity of a region. Live mobile camera systems could be used in a variety of potential applications, such as live reporting of automotive traffic, monitoring stores and banks, tracking taxis and recording police operations.

Typically, the network used for a live mobile camera system is an internet network using internet protocols. One advantage of using the internet for communication between the server system and the mobile client is that compatibility is maintained with existing network application. Use of the internet also allows the live mobile camera system to be implemented more easily, less expensively and faster since standardized networking equipment can be used.

However, one problem with using the internet for a live mobile camera system is that current internet protocols are poorly suited for transmitting realtime digital multimedia data quickly at low error rates. One internet protocol that is well known is referred to as transmission control protocol (“TCP”). TCP generally provides a reliable transmission of data with low error rates. However, TCP frequently causes long transmission delays when used in live mobile camera systems that rely on a wireless link to transmit realtime digital multimedia data. The reason for these delays is that TCP is not designed for use in wireless systems where the transmission quality is often poor compared to hard-wired transmission links. Instead, TCP assumes that all transmission errors occur due to network congestion without considering data losses due to the low quality of the transmission link. As a result, TCP introduces significant transmission delays since it repeatedly retransmits data packets that are lost or damaged during transmission.

Another internet protocol that is known is referred to as user datagram protocol (“UDP”). UDP provides faster transmission than TCP because the default procedure used by UDP discards all missing and damaged packets. UDP, however, is an unreliable protocol and is generally inadequate for applications, such as a live mobile camera systems, where high error rates are unacceptable. Thus, a method of communicating realtime digital multimedia data with shorter transmission delays and low error rates is needed.

A live mobile camera system also places a heavy load on the data servers that receive the transmitted realtime multimedia data. In traditional client-server networks, a single server is used to communicate with many clients. When heavy communication loads are expected, a backup server is sometimes also provided to handle some or all of the communications when the main server gets busy or goes off-line altogether.

Traditional server networks, however, are not able to balance the communication loads across several servers in different networks. Load balancing across multiple servers is useful in a number of networking applications but is especially important in applications, such as live mobile camera systems where heavy communication loads are expected and high reliability is required. Thus, a server cluster that balances communication loads across a number of servers in different networks is needed.

### BRIEF SUMMARY

Accordingly, a live mobile camera system is provided with a communication protocol that is especially suited for wireless links and a server cluster that balances communication loads across more than one server in different networks.

The communication protocol segments realtime digital multimedia data into segments in an application layer and packetizes the segments in an internet protocol layer. The size of the segments is varied based on packet errors that occur during transmission of the segments. User datagram protocol is preferably used as the internet protocol layer.

The server cluster includes a first tier of servers and a second tier of servers. Each of the first tier servers manage more than one of the second tier servers. The communication load on the second tier of servers is balanced by directing communication links to the second tier servers that are experiencing less load than the other second tier servers. The first tier servers may also reassign the second tier servers to other first tier servers to accommodate down time of the first tier servers or other load balancing concerns.

### BRIEF DESCRIPTION OF SEVERAL VIEWS OF THE DRAWINGS

The invention, including its construction and method of operation, is illustrated more or less diagrammatically in the drawings, in which:

FIG. 1 is a block diagram of a live mobile camera system;

FIG. 2 is a flow chart of a communication protocol;

FIG. 3 is a block diagram of the live mobile camera system, showing a mobile station establishing a communication link with a second tier server;

FIG. 4 is a block diagram of a server cluster, showing a first tier server reassigning a second tier server to another first tier server.

### DETAILED DESCRIPTION

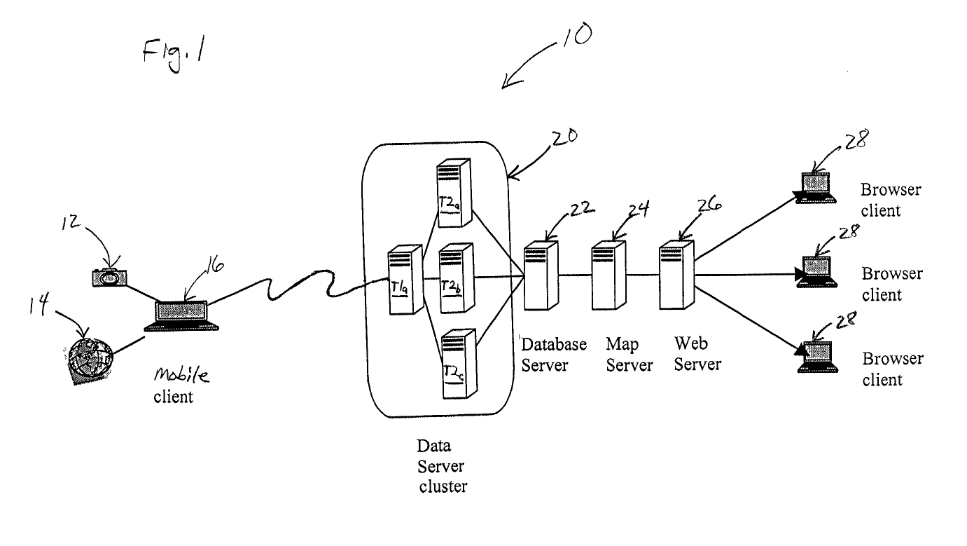

Referring now to the drawings, and particularly to FIG. 1, a live mobile camera system 10 is provided. The live mobile camera system 10 allows a user to monitor the visual surroundings around a mobile client 16 and monitor the geographical location of the mobile client 16. Typically, the user communicates with the mobile client 16 through a server system 20, 22, 24, 26 and a browser client 28.

The live mobile camera system 10 may or may not include all of the components described herein and may also include additional components not described. Typically, the live mobile camera system 10 includes a mobile client 16 which may be a standard lap top computer but preferably will be a specialized computer integrated into an automotive vehicle or housed within a monitoring station. The mobile client 16 is connected to a camera 12 for receiving realtime digital multimedia data of the visual surroundings around the mobile client 16. The mobile client 16 is also connected to a global positioning system (“GPS”) receiver 14 for collecting geographical location data for the mobile client 16.

The browser client 28 monitors the mobile client 16 through a server system 20, 22, 24, 26 using standard Hypertext Transfer Protocol (“HTTP”). The mobile client 16 may be connected to the server system 20, 22, 24, 26 through a variety of communication links, such as ground based telephone wires. However, a wireless link is preferred to provide increased mobile freedom for the mobile client 16. As will be described below, a variable segment size communication protocol 70 is provided for increasing the reliability and effective throughput of the realtime digital multimedia data transmissions over the wireless link. In addition to receiving data from the mobile client 16, the data server cluster 20 also transmits data from the browser client 28 to the mobile client 16. As will be described below, a two tier server cluster 20 is provided for improving reliability and increasing the capacity of the data server cluster 20. The data server cluster 20 is connected to a database server 22 that stores the realtime digital multimedia data and other necessary data. The server cluster 20 is also connected to a map server 24 that stores maps that are representative of the various geographical locations where the mobile client 16 may be located. The database server 22 and the map server 24 are connected to a web server 26 that receives commands from the browser client 28 and communicates requested data to the browser client 28. The browser client 28 may be any type of computer that can communicate with the server system 20, 22, 24, 26, that can receive inputs from the user, and that can display the requested data.

As is apparent, the live mobile camera system 10 is useful in a broad variety of applications where a user wishes to remotely monitor a location visually. The live mobile camera system 10 also allows the user to monitor the geographical location of the visual pictures collected by the mobile client 16. Further, when a wireless link is used between the mobile client 16 and the server system 20, 22, 24, 26 additional flexibility is possible, thereby allowing the mobile client 16 to travel between multiple locations and allowing the user to easily monitor those multiple locations.

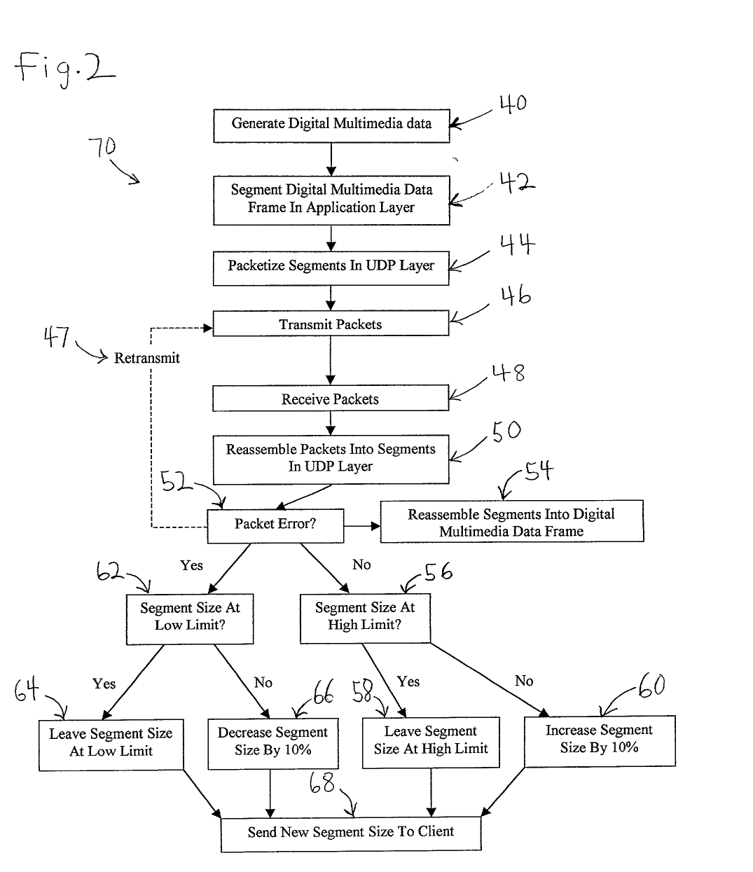

Turning now to FIG. 2, a variable segment size communication protocol 70 is provided. Generally speaking, the communication protocol 70 segments realtime digital multimedia data into smaller portions before the digital data is packetized in an internet protocol layer. The size of the segments may then be changed depending on the quality of the wireless link. Preferably, the variable packet size communication protocol 70 is used with a standard internet protocol layer known as user datagram protocol (“UDP”). Typically, UDP provides a faster transmission than the protocol known as transmission control protocol (“TCP”) since UDP does not automatically require data to be resent when one of the data packets from the digital data frame is lost or damaged. Accordingly, the application layer resends only those segments that contain missing or damaged packets, thereby increasing transmission efficiency over the wireless link.

The variable segment size communication protocol 70 starts with a generated realtime digital multimedia data frame 40. Many types of realtime digital multimedia data may be used with the communication protocol 70, but realtime digital multimedia data generated by a mobile client 16 in a live mobile camera system 10 are especially adapted for the variable segment size communication protocol 70. For purposes of example, a typical digital multimedia data frame may be about 10 kbytes in size. The digital multimedia data frame is then segmented into portions, or segments, by an application layer 42. Preferably, a default segment size is determined during the design of the application system. Thus, for example, the default segment size may be 500 bytes, thereby resulting in twenty segments of the original 10 kbyte digital data frame. Next, the UDP layer divides each segment into a number of discrete data packets which can be sent over a network 44. A UDP layer is preferred when the realtime multimedia data packets are transmitted over a wireless link, since UDP is considerably faster than TCP when the quality of the transmission link is poor. If a wireless link is used with the present invention, the data packets are then transmitted wirelessly from the mobile client 46.

The wireless data packets are next received by one of the second tier servers T2ₐ, T2_{b}, T2_{c} or other suitable receiver 48. The data packets are then reassembled into the original segments 50. Thus, in the example described, the data packets are separately reassembled into the original twenty segments. The segments are then tested to determine if any of the data packets in the segments are damaged or lost 52. If a segment is determined to have a damaged or lost data packet, a message is sent back to the mobile client to retransmit the particular segments with damaged or lost data packets 47. When all of the segments have been transmitted without any damaged or lost data packets, the segments are reassembled into the original data frame 54.

Next, the size of the segments is tested to optimize the segment size for the transmission of the next realtime digital multimedia data frame. A small segment size is desirable when the quality of the transmission link is poor to minimize the likelihood of packet errors and to decrease the size of the segments that may need to be retransmitted. On the other hand, small segments reduce transmission efficiency because each segment requires an individual data header that is used by the network to route the segments to the intended destination. Therefore, when the quality of the transmission link is good, a larger segment size is desired.

Accordingly, if none of the data packets in the first realtime digital multimedia data frame are damaged or lost during transmission, the segment size is determined to be acceptable or too small. The current segment size is then compared to a limit that represents the largest segment size that is deemed to be suitable for the transmission system 56. If the current segment size is already at the high limit, the segment size is not changed, and the segment size remains at the largest size allowed 58. However, if the current segment size is not at the high limit, the segment size is increased by ten percent 60. Similarly, if some of the data packets in the first realtime digital multimedia data frame are damaged or lost during transmission, the segment size is determined to be too large. The current segment size is then compared to a limit that represents the smallest segment size that is deemed to be suitable for the transmission system 62. If the current segment size is already at the low limit, the segment size remains at the smallest size allowed 64. However, if the current segment size is not at the low limit, the segment size is decreased by ten percent 66.

The new segment size is next sent back to the mobile client 16 for use in the second realtime digital multimedia data frame 68. Accordingly, the segment size is tested after each transmission of digital data frames to determine the optimal size of the segments within a low limit and a high limit. Thus, it is now apparent that the variable segment size communication protocol 70 provides a fast and reliable transmission that is especially suited for wireless links.

Turning now to FIGS. 1, 3 and 4, a two tier server cluster 20 is also provided. The two tier server cluster 20 includes a first tier of servers T1ₐ, T1_{b} that manage a second tier of servers T2ₐ, T2_{b}, T2_{c}, T2_{d}, T2ₑ, T2_{f}. The relationship between the two tiers of servers and between the two tier server cluster 20 and the live mobile camera system 10 is shown generally in FIG. 1. Accordingly, a request for a commuication link is received by one of the first tier servers T1ₐ. Typically, more than one first tier server T1ₐ, T1_{b} is provided, with each first tier server T1ₐ, T1_{b} managing a number of second tier servers T2ₐ, T2_{b}, T2_{c}, T2_{d}, T2ₑ, T2_{f}. The address of one of the first tier servers T1ₐ is typically stored at the mobile client 16 as the default first tier server T1ₐ to communicate with. The mobile client 16 may also be updated with backup first tier servers T1_{b} or the default first tier server T1ₐ may be changed to an alternate first tier server T1_{b} to accommodate down time of the primary first tier server T1ₐ or for other load balancing concerns.

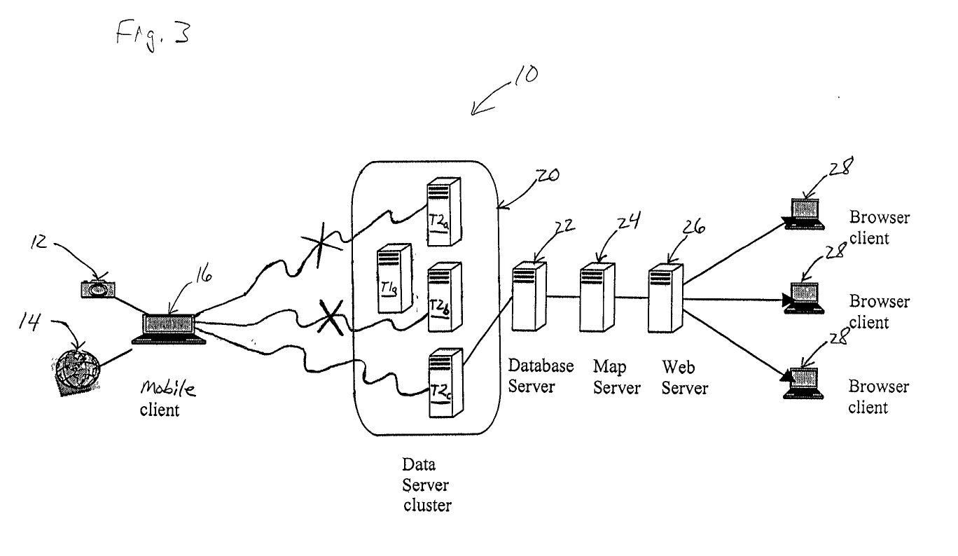

Once the first tier server T1ₐ receives a request for a communication link, the first tier server T1ₐ sends the request and the identity of the requestor to each of the second tier servers T2ₐ, T2_{b}, T2_{c} which are managed by the first tier server T1ₐ. As shown in FIG. 3, each of the second tier servers T2ₐ, T2_{b}, T2_{c} then respond to the mobile station 16, thereby indicating each server's availability for a communication link and providing the respective addresses of each of the second tier servers T2ₐ, T2_{b}, T2_{c}. Based on the communication load on each of the second tier servers T2ₐ, T2_{b}, T2_{c} or other availability issues, one of the second tier servers T2_{c} responds to the request for a communication link before the other second tier servers T2ₐ, T2_{b}. The mobile client 16 then establishes a communication link with the first responding second tier server T2_{c} and terminates communication with the later responding second tier servers T2ₐ, T2_{b}. The second tier server T2_{c} that establishes a communication link then sends the received data to the database server 22, the map server 24 and the web server 26, thereby providing a link between the mobile client 16 and a browser client 28.

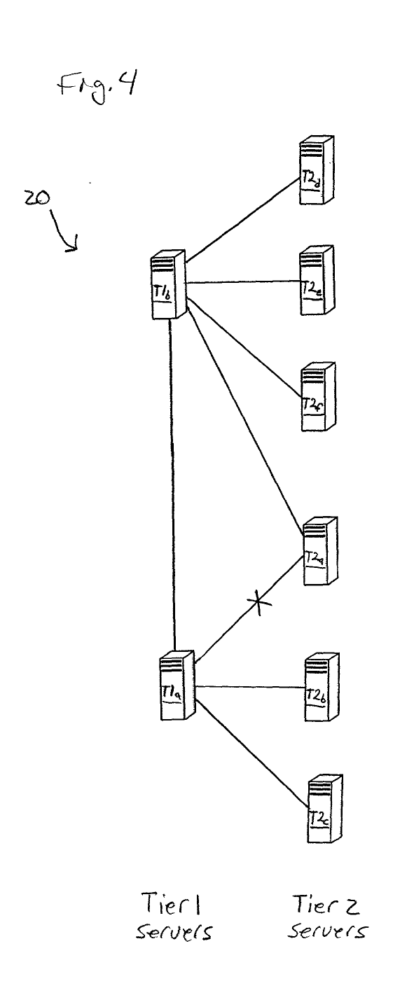

FIG. 4 shows how the management relationship between the first tier servers T1ₐ, T1_{b} and the second tier servers T2ₐ, T2_{b}, T2_{c}, T2_{d}, T2ₑ, T2_{f} may be changed to accommodate down time of the first tier servers or other load balancing concerns. When one of the first tier servers T1ₐ is about to go down, the server T1ₐ reassigns the second tier servers T2ₐ, T2_{b}, T2_{c} which are under its management to other first tier servers T1_{b}. Accordingly, the first tier server T1ₐ which is going down sends a request to another first tier server T1_{b} to accept management of one of the second tier servers T2ₐ under its management. When the other first tier server T1_{b} accepts the request, that first tier server T1_{b} and one of the second tier servers T2ₐ under the management of the first tier server T1ₐ which is about to go down initiate a management relationship. The management relationship between the first tier server T1ₐ which is about to go down and the reassigned second tier server T2ₐ is then terminated. The first tier server T1ₐ which is about to go down then repeats the reassignment procedure by sending requests to other first tier servers until the remaining second tier servers T2_{b}, T2_{c} have been reassigned.

It is now apparent that the two tier server cluster 20 provides load balancing across a number of servers by directing the communication link to a server with less load than other servers. The ability of the server cluster 20 to balance the communication load allows the server cluster 20 to handle a higher total traffic load compared to conventional server systems. Alternatively, smaller and less expensive servers may be used to achieve the same traffic capacity currently provided by faster and more expensive servers. Another advantage of the two tier server cluster 20 is that standard internet communication protocols may be used for communication between the first tier of servers and the second tier of servers and also between the servers of the first tier. Accordingly, the first tier of servers and the second tier of servers may be discrete networks of servers distinct from each other. Likewise, the groups of second tier servers that are assigned to each of the first tier servers may also be distinct and discrete networks of servers. Similarly, each of the second tier servers within a group assigned to a first tier server may be a distinct and discrete network of servers.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

I claim:

1. A communication protocol comprising segmenting digital data into segments in a first application layer; packetizing said segments in a first internet protocol layer; reassembling said packets in a second internet protocol layer; and reassembling said segments in a second application layer.

2. The communication protocol according to claim 1, further comprising testing said packets for errors; and changing a size of said segments in response to said packet testing.

3. The communication protocol according to claim 2, wherein said segment size is increased if said packet testing detects no packet errors in said digital data and said segment size is decreased if said packet testing detects a packet error in said digital data.

4. The communication protocol according to claim 2, wherein said segment size is changed between a low limit and a high limit.

5. The communication protocol according to claim 4, wherein said segment size is not changed if said packet testing detects no packet errors in said digital data and said segment size is at said high limit; said segment size is increased if said packet testing detects no packet errors in said digital data and said segment size is not at said high limit; said segment size is not changed if said packet testing detects a packet error in said digital data and said segment size is at said low limit; and said segment size is decreased if said packet testing detects a packet error in said digital data and said segment size is not at said low limit.

6. The communication protocol according to claim 1, in combination with transmitting and receiving said packets over a wireless link between said packetizing and said packet reassembling.

7. The communication protocol according to claim 1, further comprising testing said packets for errors; and retransmitting only said segments having packet errors without retransmitting said segments having no packet errors.

8. The communication protocol according to claim 1, further comprising testing said packets for errors; and retransmitting at least one of said segments in response to said packet testing from said first application layer without retransmitting from said first internet protocol layer.

9. The communication protocol according to claim 1, wherein said internet protocol layer is a user datagram protocol.

10. The communication protocol according to claim 1, in combination with generating said digital data in a live mobile camera system, said digital data being a digitized picture of the visual surroundings around a mobile client.

11. The communication protocol according to claim 1, further comprising testing said packets for errors; changing a size of said segments in response to said packet testing; and retransmitting at least one of said segments in response to said packet testing from said first application layer without retransmitting from said first internet protocol layer.

12. The communication protocol according to claim 11, wherein said segment size is increased if said packet testing detects no packet errors in said digital data and said segment size is decreased if said packet testing detects a packet error in said digital data; wherein said segment size is changed between a low limit and a high limit; and wherein only said segments having packet errors are retransmitted and said segments having no packet errors are not retransmitted.

13. The communication protocol according to claim 12, in combination with transmitting and receiving said packets over a wireless link between said packetizing and said packet reassembling; and wherein said internet protocol layer is a user datagram protocol.

14. The communication protocol according to claim 13, in combination with generating said digital data in a live mobile camera system, said digital data being a digitized picture of the visual surroundings around a mobile client.

15. The communication protocol according to claim 1, further comprising testing said packets for errors; further comprising changing a size of said segments in response to said packet testing; and in combination with transmitting and receiving said packets over a wireless link between said packetizing and said packet reassembling.

16. The communication protocol according to claim 15, wherein said internet protocol layer is a user datagram protocol.

17. A server cluster comprising a first tier and a second tier; said first tier comprising at least one server and said second tier comprising at least one server; said first tier managing said second tier; wherein said first tier receives a request for a communication link and sends said request to said second tier, said second tier thereby responding to said request.

18. A server cluster according to claim 17, wherein said second tier comprises at least two servers.

19. The server cluster according to claim 18, wherein each second tier server responds to said request and said communication link is established with the first second tier server to respond.

20. The server cluster according to claim 17, wherein said first tier comprises at least two servers whereby each of said first tier servers manages at least two second tier servers.

21. The server cluster according to claim 20, wherein one of said first tier servers reassigns one of said second tier servers managed by said reassigning first tier server to another of said first tier servers.

22. The server cluster according to claim 21, wherein said reassignment comprises said reassigning first tier server sending a message requesting acceptance of said one of said second tier servers to said another of said first tier servers, said another of said first tier servers establishing management of said one of said second tier servers upon acceptance of said requesting message.

23. The server cluster according to claim 20, wherein at least two of said first tier servers communicate with each other using an internet protocol, said at least two first tier servers being separate server networks.

24. The server cluster according to claim 20, in combination with a requester sending said request for said communication link, said requester storing an identity of one of said first tier servers as a default server to send said request to.

25. The server cluster according to claim 24, wherein said requester updates stored identities of said first tier servers, said requester selecting one of said first tier servers to send said request to.

26. The server cluster according to claim 17, wherein said first tier communicates with said second tier using an internet protocol, said first tier and said second tier being separate server networks.

27. The server cluster according to claim 26, wherein said at least two servers of said second tier are separate server networks.

28. The server cluster according to claim 17, in combination with a wireless link, said wireless link being coupled to said requested communication link.

29 The server cluster according to claim 17, in combination with a live mobile camera system comprising a mobile client with a camera, whereby said camera takes pictures of visual surroundings around said mobile client, said pictures being sent through said communication link.

30. The server cluster according to claim 18, wherein each second tier server responds to said request and said communication link is established with the first second tier server to respond; wherein said first tier comprises at least two servers whereby each of said first tier servers manages at least two second tier servers; wherein one of said first tier servers reassigns one of said second tier servers managed by said reassigning first tier server to another of said first tier servers; wherein at least two of said first tier servers communicate with each other using an internet protocol, said at least two first tier servers being separate server networks; and wherein said first tier communicates with said second tier using an internet protocol, said first tier and said second tier being separate server networks.

31. The server cluster according to claim 30, wherein said reassignment comprises said reassigning first tier server sending a message requesting acceptance of said one of said second tier servers to said another of said first tier servers, said another of said first tier servers establishing management of said one of said second tier servers upon acceptance of said requesting message; in combination with a requester sending said request for said communication link, said requestor storing an identity of one of said first tier servers as a default server to send said request to; wherein said requestor updates stored identities of said first tier servers, said requestor selecting one of said first tier servers to send said request to; in combination with a wireless link, said wireless link being coupled to said requested communication link; and in combination with a live mobile camera system comprising a mobile client with a camera, whereby said camera takes pictures of visual surroundings around said mobile client, said pictures being sent through said communication link.

32. The server cluster according to claim 18, wherein said first tier comprises at least two servers whereby each of said first tier servers manages at least two second tier servers; in combination with a requestor sending said request for said communication link, said requester storing an identity of one of said first tier servers as a default server to send said request to; wherein said requestor updates stored identities of said first tier servers, said requester thereby selecting one of said first tier servers to send said request to; in combination with a wireless link, said wireless link being coupled to said requested communication link; and in combination with a live mobile camera system comprising a mobile client with a camera, whereby said camera takes pictures of visual surroundings around the mobile client, said pictures being sent through said communication link.

33. The server cluster according to claim 32, wherein one of said first tier servers reassigns one of said second tier servers managed by said o reassigning first tier server to another of said first tier servers; wherein said reassignment comprises said reassigning first tier server sending a message requesting acceptance of said one of said second tier servers to said another of said first tier servers, said another of said first tier servers establishing management of said one of said second tier servers upon acceptance of said requesting message; wherein at least two of said first tier servers communicate with each other using an internet protocol, said at least two first tier servers being separate server networks; in combination with a requestor sending said request for said communication link, said requestor storing an identity of one of said first tier servers as a default server to send said request to; wherein said requester updates stored identities of said first tier servers, said requestor selecting one of said first tier servers to send said request to; wherein said first tier communicates with said second tier using an internet protocol, said first tier and said second tier being separate server networks.

34. A live mobile camera system comprising a mobile client with a camera generating realtime pictures of visual surroundings around said mobile client; a wireless link transmitting said pictures, wherein said pictures are transmitted over said wireless link according to a communication protocol comprising segmenting digital data into segments in a first application layer, packetizing said segments in a first internet protocol layer, reassembling said packets in a second internet protocol layer, and reassembling said segments in a second application layer; and a server cluster receiving said wireless link, wherein said server cluster comprises a first tier and a second tier, said first tier comprising at least one server and said second tier comprising at least two servers, said first tier managing said second tier, wherein said first tier receives a request for a communication link and sends said request to said second tier, said second tier thereby responding to said request.

35. The communication protocol according to claim 34, wherein said communication protocol further comprises testing said packets for errors, and changing a size of said segments in response to said packet testing, and wherein said internet protocol layer is a user datagram protocol.

36. The communication protocol according to claim 35, wherein said segment size is increased if said packet testing detects no packet errors in said digital data and said segment size is decreased if said packet testing detects a packet error in said digital data, wherein said segment size is changed between a low limit and a high limit, and wherein said communication protocol further comprises retransmitting only said segments having packet errors without retransmitting said segments having no packet errors, and retransmitting at least one of said segments in response to said packet testing from said first application layer without retransmitting from said first internet protocol layer.

37. The server cluster according to claim 34, wherein each second tier server responds to said request and said communication link is established with the first second tier server to respond, wherein said first tier comprises at least two servers whereby each of said first tier servers manages at least two second tier servers, and wherein said mobile client stores an identity of one of said first tier servers as a default server to send said request to.

38. The server cluster according to claim 37, wherein one of said first tier servers reassigns one of said second tier servers managed by said reassigning first tier server to another of said first tier servers, wherein said reassignment comprises said reassigning first tier server sending a message requesting acceptance of said one of said second tier servers to said another of said first tier servers, said another of said first tier servers establishing management of said one of said second tier servers upon acceptance of said requesting message, wherein at least two of said first tier servers communicate with each other using an internet protocol, said at least two first tier servers being separate server networks, wherein said mobile client updates stored identities of said first tier servers, said mobile client selecting one of said first tier servers to send said request to, and wherein said first tier communicates with said second tier using an internet protocol, said first tier and said second tier being separate server networks.

39. The communication protocol according to claim 34, wherein said communication protocol further comprises testing said packets for errors, and changing a size of said segments in response to said packet testing, and wherein said internet protocol layer is a user datagram protocol, wherein each second tier server responds to said request and said communication link is established with the first second tier server to respond, wherein said first tier comprises at least two servers whereby each of said first tier servers manages at least two second tier servers, and wherein said mobile client stores an identity of one of said first tier servers as a default server to send said request to.

40. The communication protocol according to claim 39, wherein said segment size is increased if said packet testing detects no packet errors in said digital data and said segment size is decreased if said packet testing detects a packet error in said digital data, wherein said segment size is changed between a low limit and a high limit, and wherein said communication protocol further comprises retransmitting only said segments having packet errors without retransmitting said segments having no packet errors, and retransmitting at least one of said segments in response to said packet testing from said first application layer without retransmitting from said first internet protocol layer, wherein one of said first tier servers reassigns one of said second tier servers managed by said reassigning first tier server to another of said first tier servers, wherein said reassignment comprises said reassigning first tier server sending a message requesting acceptance of said one of said second tier servers to said another of said first tier servers, said another of said first tier servers establishing management of said one of said second tier servers upon acceptance of said requesting message, wherein at least two of said first tier severs communicate with each other using an internet protocol, said at least two first tier servers being separate server networks, wherein said mobile client updates stored identities of said first tier servers, said mobile client selecting one of said first tier servers to send said request to, and wherein said first tier communicates with said second tier using an internet protocol, said first tier and said second tier being separate server networks.
